(19) United States
(12) Patent Application Publication
(10) Pub. No.: US 2026/0332740 A1
(43) Pub. Date: Oct. 22, 2026

(54) HEAD-MOUNTED DISPLAY, CONTROL METHOD OF HEAD-MOUNTED DISPLAY, AND NON-TRANSITORY COMPUTER-READABLE STORAGE MEDIUM

(71) Applicant: NEC Corporation, Tokyo (JP)

(72) Inventors: Masatoshi FURUKAWA, Tokyo (JP); Yusuke Mori, Tokyo (JP); Akio Yoshioka, Tokyo (JP); Yu Tsumuraya, Tokyo (JP); Sayo Minowa, Tokyo (JP)

(73) Assignee: NEC Corporation, Tokyo (JP)

(21) Appl. No.: 19/468,149

(22) Filed: Feb. 3, 2026

(30) Foreign Application Priority Data
Feb. 27, 2025 (JP) 2025-030815

(51) Int. Cl. H04N 13/398; G06F 21/32; G09B 19/00; H04N 13/194; H04N 13/383

(52) U.S. Cl. CPC H04N 13/398; G06F 21/32; G09B 19/0053; H04N 13/194; H04N 13/383

(57) ABSTRACT

A head-mounted display includes a biometric information acquisition means, an authentication means, a history control means, a history acquisition means, and a display control means. The biometric information acquisition means acquires biometric information of a user. The authentication means authenticates the user by using the acquired biometric information. The history control means generates a usage history including information related to operations of the authenticated user, and stores the generated usage history. The history acquisition means acquires the stored usage history. The display control means determines, based on the acquired usage history, an interface on a virtual reality screen or augmented reality screen.

### INCORPORATION BY REFERENCE

This application is based upon and claims the benefit of priority from Japanese Patent Application No. 2025-030815, filed on Feb. 27, 2025, the disclosure of which is incorporated herein in its entirety by reference.

### TECHNICAL FIELD

The present disclosure relates to a head-mounted display, a control method of a head-mounted display, and a non-transitory computer-readable storage medium.

### BACKGROUND ART

There exists a technique of reflecting a user's proficiency level in a screen display.

For example, Patent Literature 1 (JP2021-149792 A) describes that user-operable items to be displayed can be switched in accordance with the proficiency level.

The information processing apparatus of Patent Literature 1 performs advance settings for implementing mixed reality.

The information processing apparatus includes a proficiency acquisition unit that acquires a proficiency level of the advance settings, and a display switching unit that switches, in accordance with the proficiency level, user-operable items to be displayed for the advance settings.

There exists an HMD (Head Mounted Display) that is operated by gaze and finger movements without using a predetermined controller and the like. A user who operates such an HMD for the first time is unfamiliar with selecting an icon and the like with gaze, and may be unable to comfortably operate the HMD.

On the other hand, by continuing to use the HMD, the user becomes accustomed to selecting an icon and the like with gaze. In a case where virtual reality is implemented for a user who is accustomed to the HMD by an interface adjusted to suit a user who is not accustomed to operating the HMD, the user may feel that the HMD is sluggish. In this manner, existing HMDs have a problem in that virtual reality cannot be provided with an interface suitable for a user's state and the like.

It should be noted that Patent Literature 1 merely discloses a technique of switching display items in accordance with a user's proficiency level in settings during calibration performed by the HMD. Therefore, even in a case where the technique disclosed in Patent Literature 1 is applied, it is not possible to solve the above-described problem.

### SUMMARY

It is a main object of the present disclosure to provide a head-mounted display, a control method of a head-mounted display, and a non-transitory computer-readable storage medium that contribute to realizing comfortable operation by each user.

According to a first aspect of the present disclosure, there is provided a head-mounted display including: a biometric information acquisition means that acquires biometric information of a user; an authentication means that authenticates the user by using the acquired biometric information; a history control means that generates a usage history including information related to operations of the authenticated user, and stores the generated usage history; a history acquisition means that acquires the stored usage history; and a display control means that determines, based on the acquired usage history, an interface on a virtual reality screen or augmented reality screen.

According to a second aspect of the present disclosure, there is provided a control method of a head-mounted display, the control method including: a biometric information acquisition step that acquires biometric information of a user; an authentication step that authenticates the user by using the acquired biometric information; a history control step that generates a usage history including information related to operations of the authenticated user, and stores the generated usage history; a history acquisition step that acquires the stored usage history; and a display control step that determines, based on the acquired usage history, an interface on a virtual reality screen or augmented reality screen.

According to a third aspect of the present disclosure, there is provided a non-transitory computer-readable storage medium storing a program causing a computer mounted on a head-mounted display to perform processing for: a biometric information acquisition processing that acquires biometric information of a user; an authentication processing authenticates the user by using the acquired biometric information; a history control processing that generates a usage history including information related to operations of the authenticated user, and stores the generated usage history; a history acquisition processing that acquires the stored usage history; and a display control processing that determines, based on the acquired usage history, an interface on a virtual reality screen or augmented reality screen.

### BRIEF DESCRIPTION OF THE DRAWINGS

Exemplary features and advantages of the present disclosure will become apparent from the following detailed description when taken with the accompanying drawings in which:

FIG. 1 is a diagram for illustrating an outline of an example embodiment;

FIG. 2 is a flowchart illustrating an operation of an example embodiment;

FIG. 3 is a diagram for illustrating utilization of an HMD according to an example embodiment of the present disclosure;

FIG. 4 is a diagram illustrating an example of a screen display of an HMD according to an example embodiment of the present disclosure;

FIG. 5 is a diagram illustrating an example of a processing configuration of the HMD according to the example embodiment of the present disclosure;

FIG. 6 is a diagram illustrating an example of a user management database according to the example embodiment of the present disclosure;

FIG. 7 is a flowchart illustrating an example of an operation of a display control unit according to the example embodiment of the present disclosure;

FIG. 8 is a diagram illustrating an example of a screen display of the HMD according to the example embodiment of the present disclosure;

FIG. 9 is a diagram illustrating an example of a screen display of the HMD according to the example embodiment of the present disclosure;

FIG. 10 is a diagram illustrating an example of a processing configuration of the HMD according to a variation of the example embodiment of the present disclosure; and

FIG. 11 is a diagram illustrating an example of a hardware configuration of the HMD according to the present disclosure.

### EXAMPLE EMBODIMENT

First, an outline of an example embodiment will be described. In the following outline, various components are denoted by reference characters for the sake of convenience. That is, the following reference characters are used as examples to facilitate the understanding of the present disclosure. Thus, the description of the outline is not intended to impose any limitations. In addition, unless otherwise specified, an individual block illustrated in the drawings represents a configuration of a functional unit, not a hardware unit. An individual connection line between blocks in the drawings signifies both one-way and two-way directions. An arrow schematically illustrates a principal signal (data) flow and does not exclude bidirectionality. In the present description and drawings, elements that can be described in a like way will be denoted by a like reference character, and redundant description thereof will be omitted as needed.

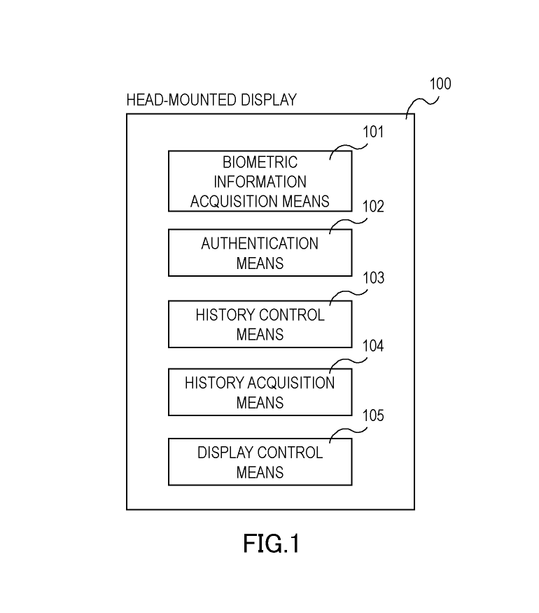

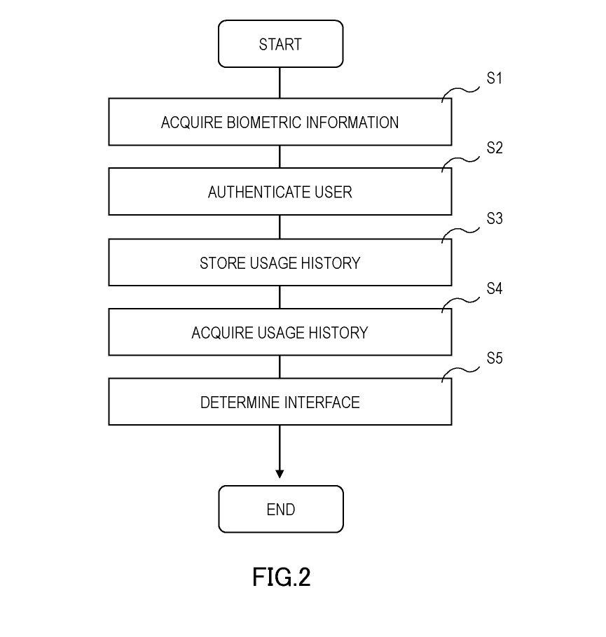

A head-mounted display (HMD) 100 according to an example embodiment includes a biometric information acquisition means 101, an authentication means 102, a history control means 103, a history acquisition means 104, and a display control means 105 (see FIG. 1). The biometric information acquisition means 101 acquires biometric information of a user (step S1 in FIG. 2). The authentication means 102 authenticates the user by using the acquired biometric information (step S2). The history control means 103 generates a usage history including information related to operations of the authenticated user, and stores the generated usage history (step S3). The history acquisition means 104 acquires the stored usage history (step S4). The display control means 105 determines, based on the acquired usage history, an interface on a virtual reality screen or augmented reality screen (step S5).

The HMD 100 determines, based on the usage history of the user, an interface suitable for the user. For example, in a case where it is determined that the user is unfamiliar with operation of the HMD 100, the HMD 100 selects a beginner interface. On the other hand, in a case where it is determined that the user is proficient in operation of the HMD 100, the HMD 100 selects an expert interface. As a result, virtual reality or augmented reality is provided by an interface suitable for each user, and comfortable operation by the user is realized.

It should be noted that, in the present disclosure, the term "interface" indicates "user interface (visual elements and operation methods)".

Hereinafter, specific example embodiments will be described in more detail with reference to drawings.

### FIRST EXAMPLE EMBODIMENT

A first example embodiment will be described in more detail with reference to drawings.

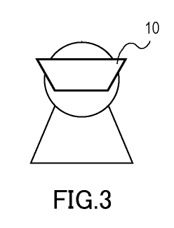

As illustrated in FIG. 3, the user wears a head-mounted display (HMD; Head Mounted Display) 10.

The HMD 10 is a virtual reality apparatus or an augmented reality apparatus that seamlessly implements fusion of the real world and virtual digital content. Goggles of the HMD 10 include a high-definition display and can superimpose and display three-dimensional digital content on the real world being visually recognized by the user.

The HMD 10 displays images on the left and right displays in the goggles, respectively. By the respective left and right images, the user can perform three-dimensional spatial recognition. In addition, the HMD 10 includes a video camera installed so as to be able to capture a direction of visual recognition of the user, and adopts a video see-through method in which digital content is superimposed and displayed on an image captured in real time by the video camera.

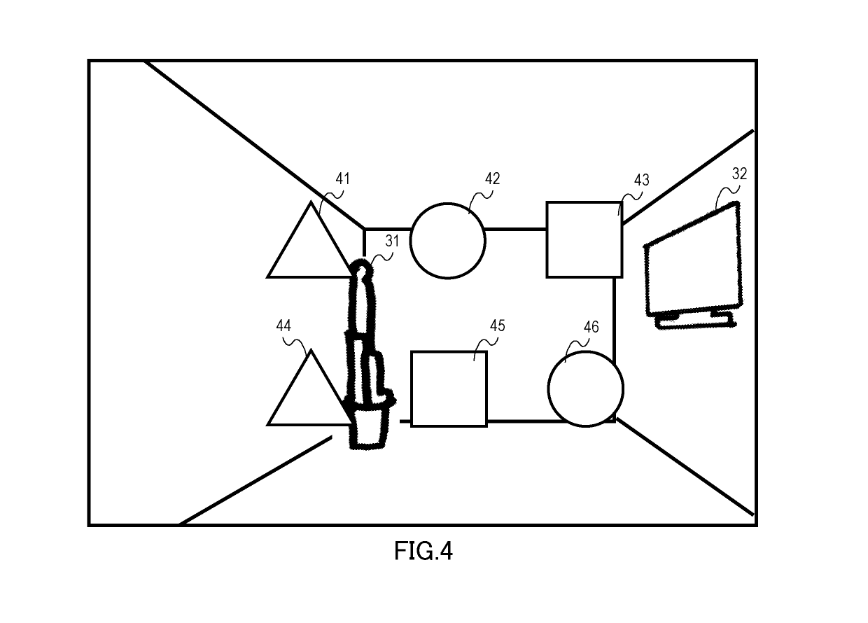

For example, in FIG. 4, a plant 31 and a television 32 are real-world objects captured by the video camera. On the other hand, icons 41 to 46 are digital content created by the HMD 10.

An OS (Operating System) is installed in the HMD 10 similarly to a smartphone and the like. In addition, an application that operates on the OS is installed in the HMD 10.

Each of icons 41 to 46 illustrated in FIG. 4 is an icon related to various settings of the HMD 10 or an icon for launching an installed application.

In addition, a screen on which icons for settings and for launching applications as illustrated in FIG. 4 are displayed is referred to as a home screen.

The HMD 10 includes a camera capable of capturing an eye (pupil, iris) of the user, and is configured to be able to detect gaze of the user (a wearer of the HMD 10). In addition, the HMD 10 includes a camera capable of capturing fingers and the like of the user, and is configured to be able to detect a gesture by the user's fingers.

The user can operate the OS and the application of the HMD 10 by gaze and a gesture. In addition, the user can also operate the OS and the application of the HMD 10 by voice.

Subsequently, details of the HMD 10 according to the first example embodiment will be described.

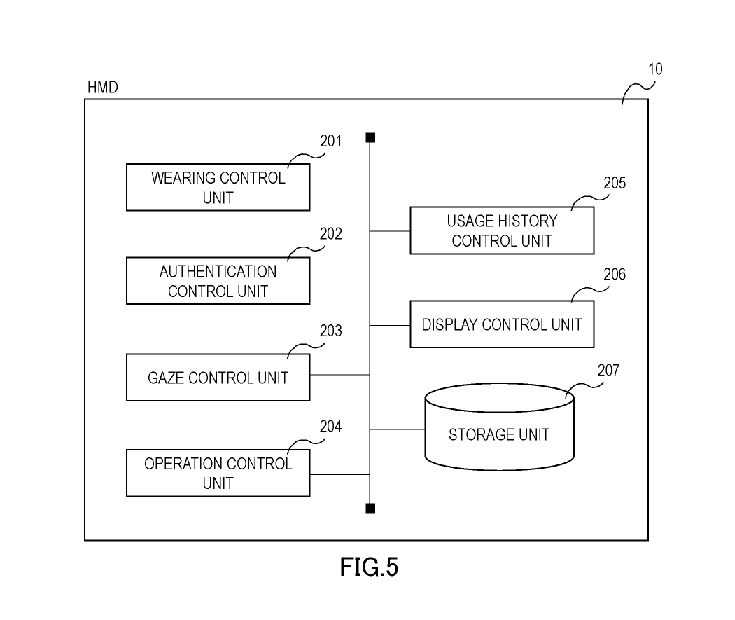

FIG. 5 is a diagram illustrating an example of a processing configuration (processing modules) of an HMD 10 according to the example embodiment of the present disclosure. Referring to FIG. 5, the HMD 10 includes a wearing control unit 201, an authentication control unit 202, a gaze control unit 203, an operation control unit 204, a usage history control unit 205, a display control unit 206, and a storage unit 207.

The wearing control unit 201 is a control means for detecting that the user has worn the HMD 10 and that the user has removed the HMD 10. The wearing control unit 201 detects start of use and end of use of the HMD 10 by the user.

The wearing control unit 201 detects that the user has worn the HMD 10 based on image data obtained from a camera installed inside the HMD 10 and an output signal obtained from a sensor. Similarly, the wearing control unit 201 detects that the user has removed the HMD 10 based on image data and the like obtained from the camera.

Upon detecting that the user has worn the HMD 10, the wearing control unit 201 notifies other modules to that effect. Similarly, upon detecting that the user has removed the HMD 10, the wearing control unit 201 notifies other modules to that effect.

The authentication control unit 202 is a means for authenticating a user who intends to use the HMD 10. The authentication control unit 202 includes a function as a biometric information acquisition means for acquiring biometric information of the user, and a function as an authentication means for authenticating the user based on the acquired biometric information.

For example, the authentication control unit 202 authenticates a user (a person to be authenticated) by using biometric information.

It should be noted that examples of the biometric information include data (feature values) calculated from physical characteristics unique to an individual, such as a face, a fingerprint, a voiceprint, a vein, a retina, and an iris pattern (pattern) of an eye. Alternatively, the biometric information may be image data such as a face image and a fingerprint image. The biometric information may be anything as long as it includes physical characteristics of the user as information. In the example embodiment of the present disclosure, a case where an iris (an iris pattern) is used will be described.

The authentication control unit 202 acquires and stores an iris feature value (an iris pattern) of the user at the time of first use by the user and the like. The authentication control unit 202 acquires and stores an iris feature value of one eye or both eyes.

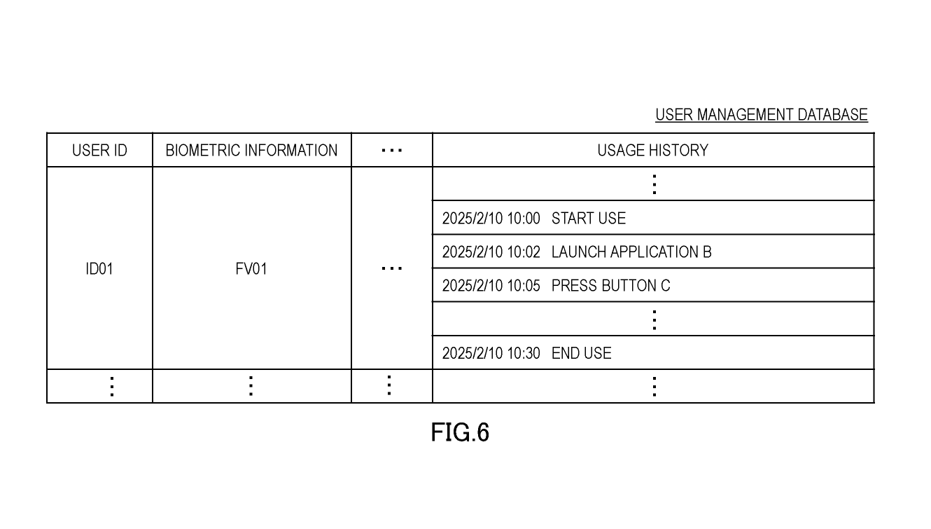

More specifically, the authentication control unit 202 assigns a user ID to a new user. The authentication control unit 202 stores, in a user management database, the user ID and biometric information (iris feature value) in association with each other (see FIG. 6). It should be noted that the user management database illustrated in FIG. 6 is an example and is not intended to limit items to be stored and the like.

In a case where the user uses the HMD 10 for a second time or later, the authentication control unit 202 authenticates the user by using the iris feature value acquired as described above. The authentication control unit 202 performs authentication processing (one-to-N authentication; N is a positive integer, the same applies hereinafter) by using an iris feature value of the user (a person to be authenticated) and a plurality of iris feature values stored in the user management database.

The authentication control unit 202 calculates a similarity between an iris feature value of the person to be authenticated and each of a plurality of iris feature values stored in the user management database.

In a case where there exists an iris feature value (an iris feature value stored in the user management database) whose similarity is equal to or greater than a predetermined value, the authentication control unit 202 determines that the authentication is successful. Upon authentication success, the user of an entry having the highest similarity is identified as the person to be authenticated.

In a case where there does not exist an iris feature value (an iris feature value stored in the user management database) whose similarity is equal to or greater than a predetermined value, the authentication control unit 202 determines that the authentication is unsuccessful.

Upon authentication success of the person to be authenticated, the authentication control unit 202 permits use of the HMD 10 by the user. Upon authentication failure of the person to be authenticated, the authentication control unit 202 rejects use of the HMD 10 by the user. Alternatively, the authentication control unit 202 performs registration of the user (registration of the user ID and the iris feature value) in response to a request from a user for whom authentication failure occurs.

Upon authentication success of the person to be authenticated, the authentication control unit 202 notifies other modules of a user ID of the user identified by the authentication processing.

It should be noted that existing techniques can be used for calculation of the iris feature value and authentication processing using the iris feature value, and detailed description thereof will be omitted.

The gaze control unit 203 is a means for performing control related to gaze of a user. For example, the gaze control unit 203 tracks the gaze of the user and identifies (estimates) a gaze direction of the user.

First, the gaze control unit 203 performs calibration for gaze tracking at the time of first use of the HMD 10 by the user.

For example, the gaze control unit 203 displays a calibration object on the screen and instructs the user to stare at the displayed object. The gaze control unit 203 stores a relationship between a position at which the object is displayed and a direction of an eye (a pupil) of the user. The gaze control unit 203 displays objects at various places in a visual field of the user and stores a relationship between the objects and the direction of the eye.

The gaze control unit 203 identifies a gaze direction by using a direction of the user's eye acquired by the calibration.

During activation of the HMD 10, the gaze control unit 203 constantly detects (tracks) a gaze direction of the user and notifies other modules of a detection result.

The operation control unit 204 is a means for performing control related to operation of the HMD 10 by the user. For example, the operation control unit 204 functions as a hand-motion detection means for detecting movement of a hand of the user.

For example, the operation control unit 204 detects an operation of the user based on image data obtained by capturing a hand and fingers of the user. For example, the operation control unit 204 detects an operation of pinching an object with a thumb and an index finger and an operation of releasing the pinched object.

For example, the operation control unit 204 detects an operation (gesture) of the user by inputting image data into an AI (Artificial Intelligence) model prepared in advance.

During activation of the HMD 10, the operation control unit 204 constantly detects an operation of the user (for example, a pinching operation and a releasing operation). In a case where the operation control unit 204 determines, based on a notification from the gaze control unit 203 and the detected operation, that the user has performed a predetermined operation, the operation control unit 204 notifies other modules to that effect.

For example, in a case where an icon is displayed on an extension line of the gaze of the user and the user performs a pinching operation, the operation control unit 204 determines that the user has performed an operation related to the icon. For example, the operation control unit 204 notifies other modules of information related to an operation such as "The setting menu has been activated." and "The application has been activated." (hereinafter referred to as operation information).

The usage history control unit 205 is a means for performing control related to a usage history of the HMD 10 by the user. The usage history control unit 205 generates a usage history including information related to operations of the authenticated user, and stores the generated usage history.

Specifically, the usage history control unit 205 generates a usage history of the user based on information notified from other modules, and stores the usage history in the user management database. The usage history control unit 205 includes a function as an update means for updating the usage history stored in the user management database.

For example, upon acquiring a user ID from the authentication control unit 202, the usage history control unit 205 recognizes a fact that the user corresponding to the user ID has started use of the HMD 10. Alternatively, upon acquiring the operation information from the operation control unit 204, the usage history control unit 205 temporarily stores the acquired operation information. Upon receiving a notification from the wearing control unit 201 that the user has removed the HMD 10, the usage history control unit 205 recognizes a fact that the user has ended use of the HMD 10.

Upon ending use of the HMD 10 by the user, the usage history control unit 205 generates a usage history of the user by using the operation information and the like temporarily stored as described above, and stores the generated usage history in the user management database.

By such an operation of the usage history control unit 205, a usage history as illustrated in FIG. 6 is stored in the user management database.

The display control unit 206 is a means for performing control related to display of the HMD 10. The display control unit 206 includes a function as a history acquisition means for acquiring a usage history stored in the user management database, and a function as a display control means for determining, based on the acquired usage history, an interface on a virtual reality screen.

The display control unit 206 superimposes and displays objects such as icons and buttons (operation target objects) on the image while displaying, by the above-described video see-through method, an image obtained by capturing the real world on the displays in the goggles. During activation of the HMD 10, the display control unit 206 repeats the operation.

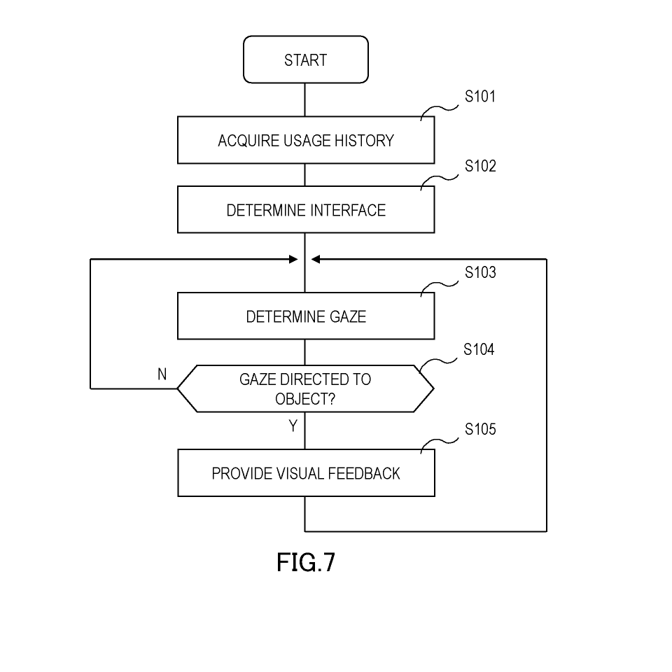

FIG. 7 is a flowchart illustrating an example of an operation of the display control unit 206 according to the example embodiment of the present disclosure. An operation of the display control unit 206 will be described with reference to FIG. 7.

Upon receiving a user ID from the authentication control unit 202 (upon start of use of the HMD 10 by the user), the display control unit 206 acquires a usage history of the user corresponding to the user ID (step S101).

Specifically, the display control unit 206 searches the user management database by using the user ID as a key and identifies a corresponding entry. The display control unit 206 reads the usage history from the identified entry.

The display control unit 206 determines, based on the acquired usage history, an interface of virtual reality to be provided to the user (determine the interface; step S102).

For example, the display control unit 206 determines the interface based on cumulative use time of the HMD 10 by the user.

Alternatively, the display control unit 206 may determine the interface based on a proficiency level of the user for operation of the HMD 10 (operation in virtual reality).

For example, the display control unit 206 calculates a proficiency level of the user by using generative AI (Artificial Intelligence). For example, the display control unit 206 generates a prompt such as "Please output the proficiency level of the user in two levels based on the usage history of the user." The display control unit 206 inputs the generated prompt together with the usage history into a large language model.

A large language model (LLM; Large Language Model) calculates a proficiency level of the user based on used applications, accuracy of operations, use time, and the like. The display control unit 206 acquires the proficiency level calculated by the large language model.

For example, in a case where, even if the use time is long, much of the use time is spent on viewing videos, the large language model calculates a low proficiency level. Alternatively, in a case where, even if the use time is short, much of the use time is spent on document creation and the like, the large language model may calculate a high proficiency level.

In a case where the display control unit 206 determines, based on the cumulative use time and the proficiency level, that the user is a "beginner", the display control unit 206 selects "for beginners" as an interface in displaying an object such as an icon. That is, in a case where the cumulative use time and the proficiency level are equal to or less than a predetermined value, the display control unit 206 recognizes that the user is a beginner who is unfamiliar with operation of the HMD 10, and displays an object on the display screen (for example, an icon and the like on the home screen) by using an interface for beginners.

In a case where the display control unit 206 determines, based on the cumulative use time and the proficiency level, that the user is an "expert", the display control unit 206 selects "for experts" as a display method of an object. That is, in a case where the cumulative use time and the proficiency level are greater than a predetermined value, the display control unit 206 recognizes that the user is an expert who is proficient in operation of the HMD 10, and displays an object on the display screen by using an interface for experts.

The display control unit 206 acquires a gaze direction of the user from the gaze control unit 203. The display control unit 206 determines, based on the acquired gaze direction, whether or not the gaze of the user is directed to an object on the screen (for example, a specific icon on the home screen) (determination of gaze; step S103).

In a case where the gaze of the user is not directed to the object (step S104, No branch), the display control unit 206 repeats the gaze determination processing of step S103 without performing any particular processing.

In a case where the gaze of the user is directed to the object (step S104, Yes branch), the display control unit 206 provides visual feedback to the object to which the gaze is directed with the interface determined as described above (step S105).

More specifically, the display control unit 206 provides visual feedback so that the user can recognize that the object has been selected. The display control unit 206 provides appropriate visual feedback corresponding to the proficiency level of the user and the like to the object selected by the user.

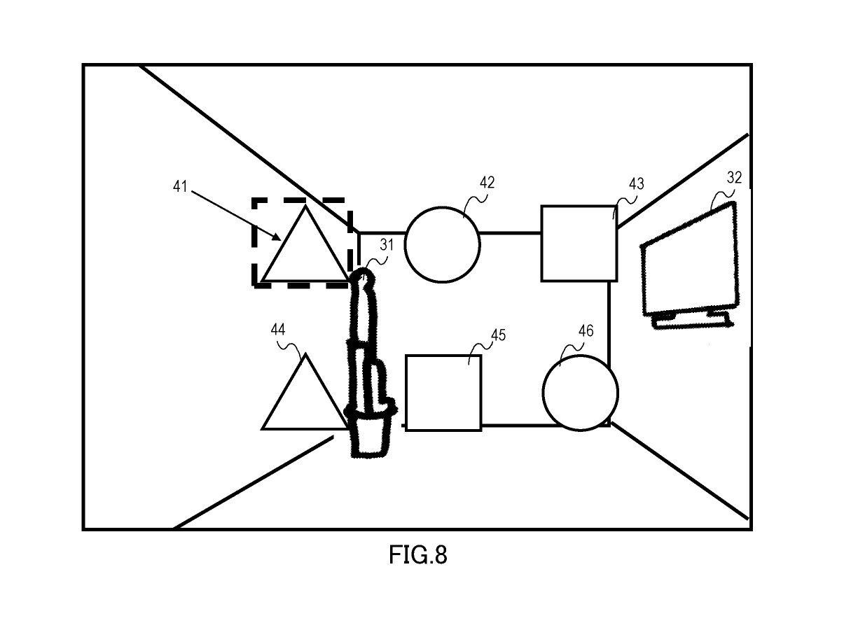

For example, a case where an interface for beginners is selected is considered. In this case, in a case where the user directs the gaze to an icon 41 illustrated in FIG. 8, the display control unit 206 provides visual feedback for beginners to the icon 41.

For example, as illustrated in FIG. 8, the display control unit 206 surrounds the icon 41 with a dotted line and the like. Alternatively, the display control unit 206 may display a star mark and an arrow in the vicinity of the icon 41, or may change a color of the icon 41.

In this manner, the display control unit 206 provides exaggerated (overstated) visual feedback to the object so that even a user unfamiliar with handling of the HMD 10 can easily recognize the object selected by the user.

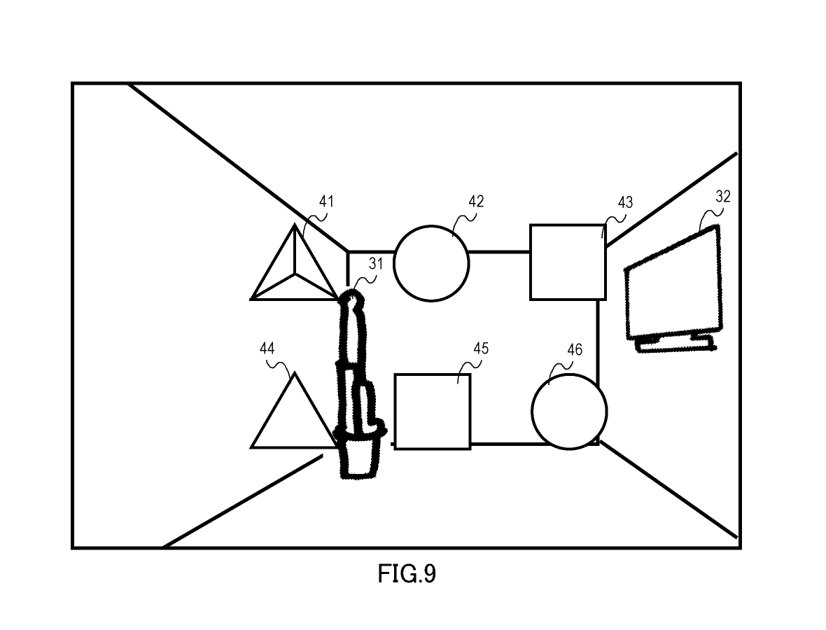

Subsequently, a case where an interface for experts is selected is considered. In a case where the user directs the gaze to an icon 41 illustrated in FIG. 9, the display control unit 206 provides visual feedback for experts to the icon 41.

For example, as illustrated in FIG. 9, the display control unit 206 displays the icon 41 three-dimensionally (a display as if a triangular pyramid is visually recognized from above).

In this manner, in a case where the user is an expert accustomed to handling of the HMD 10, the display control unit 206 provides simple visual feedback to the object selected by the user.

The display control unit 206 repeats processing of step S103 to step S105 until the user ends use of the HMD 10.

In this manner, the display control unit 206 calculates a proficiency level related to operation of the user in virtual reality based on the acquired usage history, and determines an interface on a virtual reality screen based on the calculated proficiency level. The display control unit 206 identifies, among a plurality of objects displayed on the virtual reality screen, an object being visually recognized by the user based on a gaze direction estimated by the gaze control unit 203. The display control unit 206 displays the identified object in a display mode corresponding to an interface (an interface for beginners, an interface for experts) determined based on the usage history. More specifically, the display control unit 206 provides visual feedback to the identified object based on the calculated proficiency level.

It should be noted that "display mode" refers to a visual expression method such as a size, a color, a shape, and an animation effect of an object. For example, in an interface for beginners, the display control unit 206 may display a size of the identified object in an enlarged manner, or may display characters included in the identified object in an enlarged manner. In addition, the display control unit 206 may display an outer edge of the identified object in red, or may display a cursor in the vicinity of the identified object.

The storage unit 207 is a means for storing information necessary for operation of the HMD 10.

Next, variations according to the first example embodiment will be described.

### Variation 1

Depending on the proficiency level of the user, stability of gaze and accuracy of operation may be different. Therefore, the user may be unable to obtain an optimal operational feel with uniform sensitivity settings. In consideration of such circumstances, the HMD 10 may include a function of adjusting sensitivity of gaze tracking in accordance with the proficiency level.

Specifically, the display control unit 206 adjusts sensitivity related to gaze in accordance with the proficiency level of the user. More specifically, in a case where the gaze of the user is directed to the same object for a predetermined time, the display control unit 206 determines that the object has been selected. The display control unit 206 determines (adjusts) the predetermined time based on the proficiency level of the user.

For example, for a user having a high proficiency level, the display control unit 206 sets the predetermined time described above to be short. By setting the predetermined time to be short, the object is quickly selected by following fine movements of the gaze.

Alternatively, for a user having a low proficiency level, the display control unit 206 sets the predetermined time described above to be long. By setting the predetermined time to be long, the object is selected as intended by the user.

The display control unit 206 detects an operation of the user (selection of an object) by sensitivity settings in accordance with the proficiency level.

In this manner, the display control unit 206 may adjust sensitivity in identifying an object being visually recognized by the user based on the calculated proficiency level. By such adjustment, optimal gaze tracking in accordance with the proficiency level of the user becomes possible. As a result, a more natural and intuitive operation is provided to the user.

### Variation 2

The HMD 10 may be configurable to change settings related to visual feedback. Specifically, the HMD 10 may be configured to allow the user to select, in accordance with preference of the user, a mode in providing visual feedback to an object.

For example, the HMD 10 may be configured to allow the user to set a color of a dotted line and the like that surrounds an object during visual feedback. Alternatively, the HMD 10 may be configured to allow the user to set a graphic (a star shape, an arrow, and the like) to be displayed in the vicinity of an object during visual feedback and a color of the graphic.

In this manner, the HMD 10 may be configured to allow the user to customize a mode of visual feedback. The display control unit 206 may provide visual feedback to an identified object (an object to which the gaze of the user is directed) based on a setting value selected by the user.

It should be noted that the HMD 10 may increase options (customization options) selectable by the user as the proficiency level of the user increases. For example, the HMD 10 may increase types of graphics that can be displayed in the vicinity of an object as the proficiency level of the user increases.

Alternatively, the HMD 10 may be configurable to change display-related settings other than a mode of visual feedback. For example, the HMD 10 may be configured to allow the user to set whether or not to use (whether or not to display) a cursor, an arrow, a pointer, and the like that move following the gaze.

Alternatively, the HMD 10 may determine, in accordance with the proficiency level of the user, display or non-display of a cursor and the like that move following the gaze. For example, in a case where the user is a beginner, the display control unit 206 displays a cursor and the like. On the other hand, in a case where the user is an expert, the display control unit 206 hides a cursor and the like.

In this manner, the display control unit 206 may provide, to an expert, simple visual feedback such as displaying an object three-dimensionally or changing a color of the object. For a beginner, the display control unit 206 may display a cursor and the like so that the user can easily grasp a point of the gaze (a place being stared at) recognized by the HMD 10.

### Variation 3

The HMD 10 may include a function of synchronizing a usage history (usage history information) of the user with another HMD 10. In this case, a user management database that stores the user ID and the usage history may be configured on a server on a cloud.

Upon ending operation of the HMD 10 by the user, the usage history control unit 205 transmits the user ID of the user and the usage history to the server described above. The server adds the usage history to an entry corresponding to the user ID and updates the user management database.

The display control unit 206 transmits the user ID to the server described above and acquires a usage history of the user corresponding to the user ID.

In this manner, the usage history control unit 205 may store the generated usage history in a server on a cloud. The display control unit 206 may acquire, from the server on the cloud, a usage history including a usage history of another HMD 10. By such synchronization of the usage history on the cloud, the usage history is shared among a plurality of HMDs 10. As a result, the display control unit 206 can calculate a more accurate proficiency level.

### Variation 4

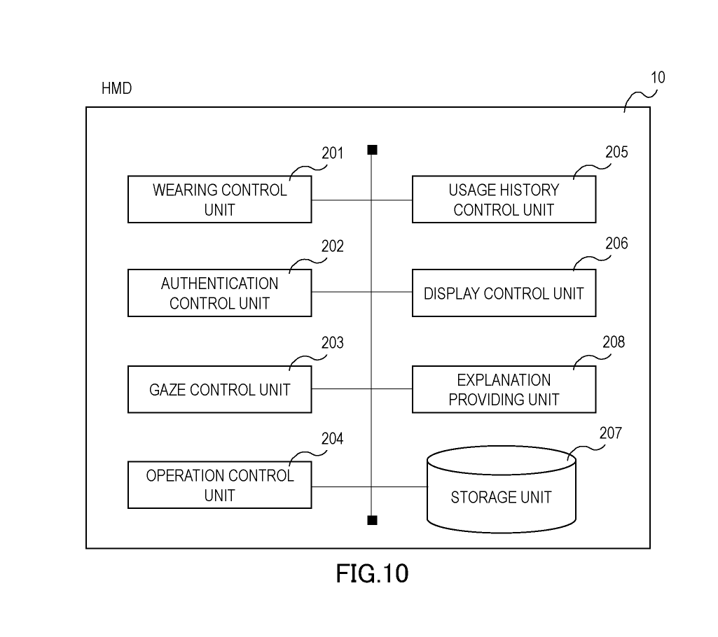

The HMD 10 may provide, in accordance with the proficiency level of the user, explanation (tutorial) of an operation method related to a new function and advanced settings. In this case, the HMD 10 may include an explanation providing unit 208 (see FIG. 10).

The explanation providing unit 208 provides, to the user, explanation of an operation method related to the new function and the like in a case where a new function and settings are added due to a version upgrade of the OS of the HMD 10 and the like. In that case, the explanation providing unit 208 may determine content to be provided in accordance with the proficiency level of the user.

For example, for an expert, the explanation providing unit 208 provides simple explanation. For a beginner, the explanation providing unit 208 provides detailed explanation.

The explanation providing unit 208 may generate explanation to be provided to the user by using generative AI such as a large language model. For example, the explanation providing unit 208 generates a prompt such as "Please create simple operation procedures for experts for new function A." and inputs the prompt into the large language model. The explanation providing unit 208 provides, to the user, the operation procedures acquired from the large language model.

In this manner, the explanation providing unit 208 may provide, to the user, a tutorial related to a function or settings, the tutorial being in accordance with the calculated proficiency level of the user.

Operations of modules such as the display control unit 206 described above are mainly implemented by an OS installed in the HMD 10. However, operations of the display control unit 206 and the like may be implemented by various applications installed in the HMD 10.

Examples of utilization of the HMD 10 by installing an application in the HMD 10 will be described below.

### Utilization Example 1

For example, the HMD 10 may be used for educational purposes.

In this case, the HMD 10 may further include a learning support unit. The learning support unit analyzes a level of understanding of the user from movements of the gaze in accordance with learning content. The learning support unit may present problems and explanation having an appropriate difficulty level based on the level of understanding of the user.

### Utilization Example 2

For example, the HMD 10 may be used for medical purposes.

In this case, the HMD 10 may further include a medical support unit. The medical support unit may adjust a level of detail of a surgical simulation and a diagnostic support system in accordance with a proficiency level of medical staff.

### Utilization Example 3

For example, the HMD 10 may be used for entertainment purposes.

In this case, the HMD 10 may further include a game adjustment unit. The game adjustment unit may automatically adjust a difficulty level and an operation method in accordance with the proficiency level of the user in a game and a VR (Virtual Reality) experience.

### Utilization Example 4

For example, the HMD 10 may be used in an industrial field.

In this case, the HMD 10 may further include a safety support unit. The safety support unit may provide safety warnings and guidance in accordance with a proficiency level of a worker in work at a factory or a construction site.

### Utilization Example 5

For example, the HMD 10 may be used in a retail store and the like.

In this case, the HMD 10 may further include a customer service support unit. The customer service support unit may display support information related to customer service and product explanation in accordance with a proficiency level of store staff.

As described above, the HMD 10 according to the first example embodiment determines, based on a usage history of a user, an interface suitable for the user. For example, in a case where it is determined that the user is unfamiliar with operation of the HMD 100, the HMD 10 selects an interface for beginners. On the other hand, in a case where it is determined that the user is proficient in operation of the HMD 10, the HMD 10 selects an interface for experts. As a result, virtual reality is provided by an interface suitable for each user, and comfortable operation by the user is realized.

The HMD 10 implements an optimal interface and operational feel in accordance with the proficiency level of the user by cooperation of components such as the gaze control unit 203, the operation control unit 204, and the display control unit 206. As a result, user experience is improved. In addition, since an optimal interface in accordance with the proficiency level of the user is provided, a learning curve of a beginner becomes gentler, and operation efficiency of an expert is improved. In addition, since sensitivity of gaze tracking is adjusted in accordance with the proficiency level of the user, the HMD 10 implements a more natural and intuitive operational feel. In addition, the HMD 10 according to the present disclosure can be utilized in various fields (for example, education, medical care, entertainment, industry, retail, and the like), and can provide support functions specialized for respective fields.

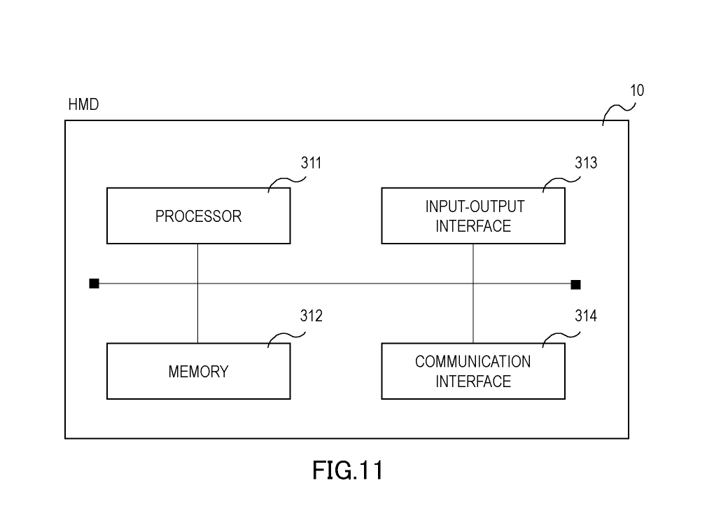

Next, a hardware configuration of an individual apparatus that constitutes the information processing system will be described. FIG. 11 is a diagram illustrating an example of a hardware configuration of the HMD 10.

The HMD 10 can be configured by an information processing apparatus (a so-called computer) and has a configuration illustrated as an example in FIG. 11. For example, the HMD 10 includes a processor 311, a memory 312, an input-output interface 313, a communication interface 314, and the like. The above-described components such as the processor 311 are connected via an internal bus or the like and are configured to be capable of communicating with each other.

However, the configuration shown in FIG. 11 is not intended to limit the hardware configuration of the HMD 10. The HMD 10 may include hardware not illustrated in the figure, and may omit the input-output interface 313 as needed. In addition, the number of components such as the processor 311 included in The HMD 10 is not intended to be limited to the example shown in FIG. 11, and, for example, a plurality of processors 311 may be included in The HMD 10.

For example, the processor 311 is a programmable device such as a CPU (Central Processing Unit), an MPU (Micro Processing Unit), or a DSP (Digital Signal Processor). Alternatively, the processor 311 may be a device such as an FPGA (Field Programmable Gate Array) or an ASIC (Application Specific Integrated Circuit). The processor 311 executes various kinds of programs including an operating system (OS).

The memory 312 is a RAM (Random Access Memory), a ROM (Read-Only Memory), an HDD (Hard Disk Drive), an SSD (Solid State Drive), and the like. The memory 312 stores an OS program, an application program, and various kinds of data.

The input-output interface 313 is an interface for a display apparatus and an input apparatus not illustrated. The display apparatus is, for example, a liquid crystal display and the like. For example, the input apparatus is an apparatus that receives user operations, and examples of the input apparatus include a keyboard and a mouse.

The communication interface 314 is a circuit, a module, and the like for performing communication with other apparatuses. For example, the communication interface 314 includes an NIC (Network Interface Card) and the like.

The functions of the HMD are realized by various kinds of processing modules. The processing modules are realized, for example, by causing the processor 311 to execute a program stored in the memory 312. In addition, this program can be recorded in a computer-readable storage medium. The storage medium may be a non-transient (non-transitory) storage medium, such as a semiconductor memory, a hard disk, a magnetic recording medium, or an optical recording medium. That is, the present disclosure can be embodied as a computer program product. In addition, the above program may be updated by downloading a program via a network or by using a storage medium in which a program is stored. In addition, the above processing modules may be realized by semiconductor chips.

The HMD 10, which is an information processing apparatus, is equipped with a computer, and the functions of The HMD 10 can be realized by causing the computer to execute a program. In addition, the HMD 10 executes a control method of the HMD 10 by using the program.

### VARIATIONS

It should be noted that the configurations, operations, and the like of the information processing system according to the above example embodiment are examples and are not intended to limit configurations and the like of the system.

In the example embodiment described above, description has been made by taking, as an example, the HMD 10 adopting a video see-through method. However, the HMD 10 may perform screen display by adopting an optical see-through method.

In the flowcharts and sequence diagrams used in the above description, a plurality of steps (processes) are sequentially described. However, the order of the execution of the steps performed in the individual example embodiment is not limited to the described order. In the individual example embodiment, the order of the illustrated steps may be changed to the extent that a problem is not caused on the content of the individual example embodiment. For example, individual processes may be executed in parallel.

The above example embodiments have been described in detail to facilitate the understanding of the present application disclosed and not to mean that all the configurations described above are needed. In addition, if a plurality of example embodiments have been described, each of the example embodiments may be used individually or a plurality of example embodiments may be used in combination. For example, part of a configuration according to one example embodiment may be replaced by a configuration according to another example embodiment. For example, a configuration according to one example embodiment may be added to a configuration according to another example embodiment. In addition, addition, deletion, or replacement is possible between part of a configuration according to one example embodiment and another configuration.

The industrial applicability of the present disclosure has been made apparent by the above description. That is, the present disclosure is suitably applicable, for example, to a head-mounted display and the like that seamlessly implement fusion of the real world and virtual digital content.

The present disclosure provides a technical means for solving specific technical problems, rather than merely an abstract idea or execution of software. In particular, the present disclosure improves operability of existing AR (Augmented Reality) / VR (Virtual Reality) devices by combining specific technical features of authentication using biometric information of a user, gaze tracking, and interface adjustment in accordance with a proficiency level. As a result, user experience is improved. As a specific example embodiment, there is application in a medical field. For example, by applying the present disclosure to a surgical training system, a level of detail and a difficulty level of a surgical simulation can be automatically adjusted in accordance with the proficiency level of a resident. This brings about specific and useful results of effectively supporting improvement of skills of the resident and contributing to improvement of quality of medical care. As described above, the present disclosure goes beyond an abstract idea, solves real-world problems by using a specific technical means, produces useful and specific results, and has patent eligibility.

A part or the entirety of the example embodiments described above may be described as in the following supplementary notes, but is not limited to the followings.

### Supplementary Note 1

A head-mounted display including:
a biometric information acquisition means that acquires biometric information of a user;
an authentication means that authenticates the user by using the acquired biometric information;
a history control means that generates a usage history including information related to operations of the authenticated user, and stores the generated usage history;
a history acquisition means that acquires the stored usage history; and a display control means that determines, based on the acquired usage history, an interface on a virtual reality screen or augmented reality screen.

### Supplementary Note 2

The head-mounted display according to supplementary note 1, further including a gaze control means that estimates a gaze direction of the user, and

wherein the display control means identifies, among a plurality of objects displayed on the virtual reality screen or augmented reality screen, an object being visually recognized by the user based on the estimated gaze direction, and displays the identified object in a display mode corresponding to the determined interface.

### Supplementary Note 3

The head-mounted display according to supplementary note 2, wherein the display control means calculates a proficiency level related to an operation of the user in the virtual reality screen or augmented reality based on the acquired usage history, and determines the interface based on the calculated proficiency level.

### Supplementary Note 4

The head-mounted display according to supplementary note 3, wherein the display control means provides visual feedback to the identified object based on the calculated proficiency level.

### Supplementary Note 5

The head-mounted display according to supplementary note 4, wherein the display control means adjusts sensitivity in identifying the object being visually recognized by the user based on the calculated proficiency level.

### Supplementary Note 6

The head-mounted display according to supplementary note 5, wherein the display control means provides the visual feedback to the identified object based on a setting value selected by the user.

### Supplementary Note 7

The head-mounted display according to any one of supplementary notes 1 to 6, wherein the history control means stores the generated usage history in a server on a cloud, and

wherein the history acquisition means acquires, from the server on the cloud, the usage history including the usage history of another head-mounted display.

### Supplementary Note 8

The head-mounted display according to any one of supplementary notes 3 to 6, further including a providing means that provides, to the user, a tutorial related to a function or settings, the tutorial being in accordance with the calculated proficiency level.

### Supplementary Note 9

A control method of a head-mounted display, the control method including:
a biometric information acquisition step that acquires biometric information of a user;
an authentication step that authenticates the user by using the acquired biometric information;
a history control step that generates a usage history including information related to operations of the authenticated user, and stores the generated usage history;
a history acquisition step that acquires the stored usage history; and a display control step that determines, based on the acquired usage history, an interface on a virtual reality screen or augmented reality screen.

### Supplementary Note 10

The control method of the head-mounted display according to supplementary note 9, further including a gaze control step that estimates a gaze direction of the user, and

wherein the display control step identifies, among a plurality of objects displayed on the virtual reality screen or augmented reality screen, an object being visually recognized by the user based on the estimated gaze direction, and displays the identified object in a display mode corresponding to the determined interface.

### Supplementary Note 11

The control method of the head-mounted display according to supplementary note 10, wherein the display control step calculates a proficiency level related to an operation of the user in the virtual reality screen or augmented reality based on the acquired usage history, and determines the interface based on the calculated proficiency level.

### Supplementary Note 12

The control method of the head-mounted display according to supplementary note 11, wherein the display control step provides visual feedback to the identified object based on the calculated proficiency level.

### Supplementary Note 13

The control method of the head-mounted display according to supplementary note 12, wherein the display control step adjusts sensitivity in identifying the object being visually recognized by the user based on the calculated proficiency level.

### Supplementary Note 14

The control method of the head-mounted display according to supplementary note 13, wherein the display control step provides the visual feedback to the identified object based on a setting value selected by the user.

### Supplementary Note 15

The control method of the head-mounted display according to any one of supplementary notes 9 to 14, wherein the history control step stores the generated usage history in a server on a cloud, and

wherein the history acquisition step acquires, from the server on the cloud, the usage history including the usage history of another head-mounted display.

### Supplementary Note 16

The control method of the head-mounted display according to any one of supplementary notes 11 to 14, further including a providing step that provides, to the user, a tutorial related to a function or settings, the tutorial being in accordance with the calculated proficiency level.

### Supplementary Note 17

A program causing a computer mounted on a head-mounted display to perform processing for:
a biometric information acquisition processing that acquires biometric information of a user;
an authentication processing authenticates the user by using the acquired biometric information;
a history control processing that generates a usage history including information related to operations of the authenticated user, and stores the generated usage history;
a history acquisition processing that acquires the stored usage history; and
a display control processing that determines, based on the acquired usage history, an interface on a virtual reality screen or augmented reality screen.

### Supplementary Note 18

The program according to supplementary note 17, further performing a gaze control processing that estimates a gaze direction of the user, and wherein the display control processing identifies, among a plurality of objects displayed on the virtual reality screen or augmented reality screen, an object being visually recognized by the user based on the estimated gaze direction, and displays the identified object in a display mode corresponding to the determined interface.

### Supplementary Note 19

The program according to supplementary note 18, wherein the display control processing calculates a proficiency level related to an operation of the user in the virtual reality screen or augmented reality based on the acquired usage history, and determines the interface based on the calculated proficiency level.

### Supplementary Note 20

The program according to supplementary note 19, wherein the display control processing provides visual feedback to the identified object based on the calculated proficiency level.

### Supplementary Note 21

The program according to supplementary note 20, wherein the display control processing adjusts sensitivity in identifying the object being visually recognized by the user based on the calculated proficiency level.

Supplementary Note 22 The program according to supplementary note 21, wherein the display control processing provides the visual feedback to the identified object based on a setting value selected by the user.

### Supplementary Note 23

The program according to any one of supplementary notes 17 to 22, wherein the history control processing stores the generated usage history in a server on a cloud, and

wherein the history acquisition processing acquires, from the server on the cloud, the usage history including the usage history of another head-mounted display.

### Supplementary Note 24

The program according to any one of supplementary notes 19 to 22, further performing a providing processing that provides, to the user, a tutorial related to a function or settings, the tutorial being in accordance with the calculated proficiency level.

In addition, a part or all of the configurations described in supplementary notes 2 to 8, which are dependent on supplementary note 1 as described above, may also be dependent on supplementary notes 9 and 17 in the same dependent relationship as supplementary notes 2 to 8. Furthermore, not limited to supplementary note 1 and supplementary notes 9 and 17, within a range not departing from the above-described example embodiments, a part or all of the configurations described as supplementary notes can likewise be made dependent on various hardware, software, various recording means for recording the software, or systems.

The entire disclosure of the above patent literature is incorporated herein by reference thereto. While the example embodiments of the present disclosure have thus been described, the present disclosure is not limited to these example embodiments. It is to be understood to those skilled in the art that these example embodiments are only examples and that various variations are possible without departing from the scope and spirit of the present disclosure. That is, the present disclosure of course includes various variations and modifications that could be made by those skilled in the art in accordance with the overall disclosure including the claims and the technical concept.

The previous description of embodiments is provided to enable a person skilled in the art to make and use the present disclosure. Moreover, various modifications to these example embodiments will be readily apparent to those skilled in the art, and the generic principles and specific examples defined herein may be applied to other embodiments without the use of inventive faculty. Therefore, the present disclosure is not intended to be limited to the example embodiments described herein but is to be accorded the widest scope as defined by the limitations of the claims and equivalents. Further, it is noted that the inventor's intent is to retain all equivalents of the claimed disclosure even if the claims are amended during prosecution.

What is claimed is:

1. A head-mounted display comprising:
at least one memory storing a set of instructions; and
at least one processor configured to execute the set of instructions to:
acquire biometric information of a user;
authenticate the user by using the acquired biometric information;
generate a usage history including information related to operations of the authenticated user;
store the generated usage history;
acquires the stored usage history; and
determine, based on the acquired usage history, an interface on a virtual reality screen or augmented reality screen.

2. The head-mounted display according to claim 1, wherein
the at least one processor is further configured to execute the set of instructions to:
estimate a gaze direction of the user;
identify, among a plurality of objects displayed on the virtual reality screen or augmented reality screen, an object being visually recognized by the user based on the estimated gaze direction; and
display the identified object in a display mode corresponding to the determined interface.

3. The head-mounted display according to claim 2, wherein
the at least one processor is further configured to execute the set of instructions to:
calculate a proficiency level related to an operation of the user in the virtual reality screen or augmented reality based on the acquired usage history; and
determine the interface based on the calculated proficiency level.

4. The head-mounted display according to claim 3, wherein
the at least one processor is further configured to execute the set of instructions to provides visual feedback to the identified object based on the calculated proficiency level.

5. The head-mounted display according to claim 4, wherein
the at least one processor is further configured to execute the set of instructions to adjust sensitivity in identifying the object being visually recognized by the user based on the calculated proficiency level.

6. The head-mounted display according to claim 5, wherein
the at least one processor is further configured to execute the set of instructions to provide the visual feedback to the identified object based on a setting value selected by the user.

7. The head-mounted display according to claim 1, wherein
the at least one processor is further configured to execute the set of instructions to:
store the generated usage history in a server on a cloud; and
acquire, from the server on the cloud, the usage history including the usage history of another head-mounted display.

8. The head-mounted display according to claim 2, wherein
the at least one processor is further configured to execute the set of instructions to:
store the generated usage history in a server on a cloud; and
acquire, from the server on the cloud, the usage history including the usage history of another head-mounted display.

9. The head-mounted display according to claim 3, wherein
the at least one processor is further configured to execute the set of instructions to:
store the generated usage history in a server on a cloud; and
acquire, from the server on the cloud, the usage history including the usage history of another head-mounted display.

10. The head-mounted display according to claim 4, wherein
the at least one processor is further configured to execute the set of instructions to:
store the generated usage history in a server on a cloud; and
acquire, from the server on the cloud, the usage history including the usage history of another head-mounted display.

11. The head-mounted display according to claim 5, wherein
the at least one processor is further configured to execute the set of instructions to:
store the generated usage history in a server on a cloud; and
acquire, from the server on the cloud, the usage history including the usage history of another head-mounted display.

12. The head-mounted display according to claim 6, wherein
the at least one processor is further configured to execute the set of instructions to:
store the generated usage history in a server on a cloud; and
acquire, from the server on the cloud, the usage history including the usage history of another head-mounted display.

13. The head-mounted display according to claim 3, wherein
the at least one processor is further configured to execute the set of instructions to provide, to the user, a tutorial related to a function or settings, the tutorial being in accordance with the calculated proficiency level.

14. A control method of a head-mounted display, the control method comprising:
acquiring biometric information of a user;
authenticating the user by using the acquired biometric information;
generating a usage history including information related to operations of the authenticated user;
storing the generated usage history;
acquiring the stored usage history; and
determining, based on the acquired usage history, an interface on a virtual reality screen or augmented reality screen.

15. A non-transitory computer-readable storage medium storing a program causing a computer mounted on a head-mounted display to perform processing for:
acquiring biometric information of a user;
authenticating the user by using the acquired biometric information;
generating a usage history including information related to operations of the authenticated user;
storing the generated usage history;
acquiring the stored usage history; and
determining, based on the acquired usage history, an interface on a virtual reality screen or augmented reality screen.
